(19) United States
(12) Patent Application Publication
(10) Pub. No.: US 2012/0175421 A1
(43) Pub. Date: Jul. 12, 2012

(54) Optical-Information-Reading Apparatus and Control Method Thereof

(75) Inventors: Katsuyuki Murata, Saitama (JP); Iwao Shimizu, Saitama (JP)

(73) Assignee: Optoelectronics Co., Ltd., Saitama (JP)

(21) Appl. No.: 13/414,060

(22) Filed: Mar. 7, 2012

Related U.S. Application Data
(63) Continuation of application No. PCT/JP2010/065983, filed on Sep. 15, 2010.

(30) Foreign Application Priority Data
Sep. 17, 2009 (JP) 2009-216184

(51) Int. Cl. G06K 7/14

(52) U.S. Cl. 235/462.31

(57) ABSTRACT

In a non-reading mode, a bar code is detected by irradiating it with a laser beam from a laser source, power consumption of which is reduced, and it is determined whether or not the detected bar code is correct. The mode is changed from the non-reading mode to a reading mode in which the laser source operates at substantially full power if it is determined that the code symbol is correct. The non-reading mode continues if it is determined that the code symbol is not correct. This enables an auto-trigger function that triggers reading of the bar code automatically. Therefore, it is possible to eliminate conventional parts and/or special-purpose circuits for realizing the auto-trigger function so that the optical-information-reading apparatus can be downsized.

This patent application is a continuation of International Application No. PCT/JP2010/065983 filed Sep. 15, 2010 and designating the United States of America. This international application was published in Japanese on Mar. 24, 2011 under No. WO 2010/034107 A1. This international application is hereby incorporated herein by reference in its entirety.

### BACKGROUND OF THE INVENTION AND SUMMARY

The present invention relates to an optical-information-reading apparatus which reads information in code symbols composed of portions having different optical reflectivity and a control method thereof. It particularly relates to an auto-trigger function which triggers reading of the code symbol automatically from a standby state thereof.

Information terminals which deliver and/or receive merchandise information to and/or from a host computer, read a code symbol such as a bar code or a two-dimensional code that is applied to goods, and display the information on a liquid crystal display thereof, to manage it, have often been used in merchandise stock management and sales management thereof. They are known as a “handy terminal”, which can be carried by an operator and can gather any information from any goods shelves, and he can check the information together with another operator. Such terminals are thus very convenient for use.

Further, it is desirable that terminals intended for the above-mentioned operation be equipped with a paper detection function, namely, an auto-trigger function by which they are switched on immediately when they detect the code symbol. Further, in a carrying service in which goods are carried on a conveyer belt and in its operation, even if an apparatus scans a code symbol, such an auto-trigger function is a great convenience.

The auto-trigger function starts, for example, when an operator sets a function key of the apparatus. Further, the auto-trigger function may be set automatically when a when the apparatus is not operated for a given period of time. When the auto-trigger function is set, electric power is stopped to a laser source irradiating a code symbol with a laser beam, enabling reduced power consumption. When a photo-sensor detects the presence of an object under a condition of such reduced power consumption, the electric power to the laser source is resumed, to trigger reading of the bar code by irradiating it with the laser beam.

In connection with such a conventional example, Patent Document 1 (see below) discloses an apparatus for reading a bar code, which is equipped with the auto-trigger function. According to Patent Document 1, when a given period of time has elapsed since a timer is set, a laser source turns off and when a sensor detects an object, the laser source turns on, to irradiate the bar code with the laser source.

Further, Patent Document 2 (see below), discloses a fixed apparatus for reading a bar code, which is equipped with a test mode for testing reading of information on a code symbol such as a bar code. According to Patent Document 2, a photoelectric switch detects an object carried by a conveyer; this photoelectric switch emits light from a floodlight portion towards a light-receiving portion thereof to detect the object carried by the conveyer. When the photoelectric switch detects the object, an apparatus for reading the bar code drives a laser-lighting circuit to irradiate the bar code with the laser beam from a light-emitting element.

### PRIOR ART DOCUMENTS

Patent Document 1: Japanese Patent Application Publication No. H09-259214
Patent Document 2: Japanese Patent Application Publication No. H09-6886

Patent Document 1 has an object-detecting sensor to realize the auto-trigger function. Via this object-detecting sensor, the object is detected by turning on the turned-off laser source, to irradiate the bar code with the laser source. Similarly, Patent Document 2 is provided with a photoelectric switch to realize the auto-trigger function.

However, since, in the above-mentioned handy terminal, or the like, an inner substrate thereof has been densified, there are many cases where it is very difficult to add parts such as a sensor and/or circuits therefor. If sensor parts and/or circuits therefor are added to realize the auto-trigger function as the conventional example, it presents the problem that the number of parts is increased so that the apparatus is enlarged.

In order to solve the above-mentioned problem, embodiments in accordance with the present invention provide an optical-information-reading apparatus that reads information on code symbol composed of portions having different optical reflectivity. Reading of the code symbol which is irradiated with laser beam from laser source, occurs in a reading mode and detecting the code symbol, which is irradiated with laser beam from laser source, power consumption of which is reduced, occurs in a non-reading mode. The apparatus has a signal-converting unit that receives reflected light of the laser beam with which the code symbol is irradiated from the laser source to convert it to an electric signal. A signal-processing unit binarizes the electric signal to generate a binarized signal, and a control unit decodes the binarized signal to detect a code symbol. The control unit decides whether or not the code symbol detected in the non-reading mode is correct and changes the mode from the non-reading mode to the reading mode based on the result of the decision.

Further, in order to solve the above-mentioned problem, embodiments of the present invention utilize a control method for an optical-information-reading apparatus that reads information on a target to be read such as a code symbol which is composed of portions having different optical reflectivity. An operation of reading the code symbol which is irradiated with a laser beam from a laser source is defined as a reading mode and an operation of detecting the code symbol which is irradiated with the laser beam from laser source, power consumption of which is reduced, is defined as a non-reading mode. The apparatus performs a first step of receiving reflected light of the laser beam with which the code symbol is irradiated by the laser source to convert it to an electric signal, a second step of binarizing the electric signal to generate a binarized signal, and a third step of decoding the binarized signal to detect a code symbol, wherein the third step includes a sub-step of deciding whether or not a code symbol detected in the non-reading mode is correct and changing the mode from the non-reading mode to the reading mode based on a result of the decision.

In embodiments of the present invention, the control unit changes mode from the non-reading mode to the reading mode if it decides that the code symbol detected in the non-reading mode is correct. It continues the non-reading mode if it decides that the code symbol is not correct. This enables the auto-trigger function that starts reading the code symbol automatically to be realized using an existing laser source.

The control unit compares a number of sample of the code symbol detected in the non-reading mode with a reference number of samples of the code symbol and decides that the detected code symbol is correct if the number of detected samples is within a range of the reference number of samples and if a value of each detected sample of the code symbol thus detected does not exceed a value of a reference sample of the code symbol when comparing the value of each detected sample of the code symbol with the value of a reference sample of the code symbol.

According to embodiments of the present invention, the code symbol is detected which is irradiated with the laser beam from the laser source, power consumption of which is reduced in a non-reading mode. It is decided whether or not the detected code symbol is correct. The mode is changed from the non-reading mode to the reading mode if it is decided that the detected code symbol is correct. The non-reading mode continues if it is decided that the detected code symbol is not correct.

This enables the auto-trigger function that triggers reading of the code symbol automatically to be realized using an existing laser source. Therefore, it is possible to eliminate any conventional parts and/or special-purpose circuits for realizing the auto-trigger function so that the optical-information-reading apparatus can be downsized.

### BRIEF DESCRIPTION OF THE DRAWINGS

FIG. 1 is a block diagram showing a configuration example of a bar code scanner 100;

FIG. 2 is a block diagram showing a configuration example of a binarization processing unit 7g;

FIG. 3 is a flowchart showing a processing example of an auto-trigger function; and

FIG. 4 is a flowchart showing a processing example of a paper detection.

### DETAILED DESCRIPTION

The following will describe embodiments of an optical-information-reading apparatus and a control method thereof embodying to the present invention with reference to drawings. A code symbol is detected which is irradiated with a laser beam from a laser source, power consumption of which is reduced in non-reading mode, it is decided whether or not the detected code symbol is correct, and the non-reading mode is changed to the reading mode based on the result of the decision, thereby enabling the auto-trigger function that triggers reading of the code symbol automatically to be realized using an existing laser source.

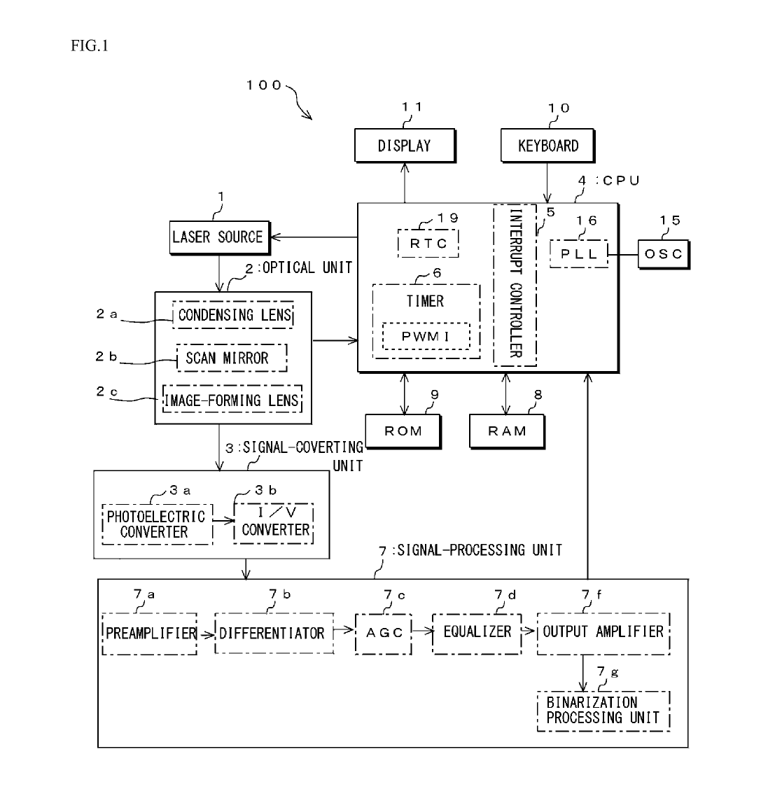

A bar code scanner 100 shown in FIG. 1 is an example of an optical-information-reading apparatus and is a fixed bar code scanner to be used when reading bar codes of goods carried on a conveyer belt in a carrying service, as one example thereof. Of course, use of the bar code scanner 100 is not limited thereto: it may be applied to a portable bar code scanner.

The bar code scanner 100 is provided with a laser source 1, an optical unit 2, a signal-converting unit 3, a CPU 4, an interrupt controller 5, a timer 6, a signal-processing unit 7, a random access memory (RAM) 8, a read only memory (ROM) 9, a key board 10, a display 11, an oscillator (OSC) 15, a phase locked loop (PLL) circuit 16 and a real time clock (RTC) circuit 19.

The laser source 1 irradiates a bar code with a beam. A bar code is an example of a code symbol composed of portions having different optical reflectivity. For example, the laser source 1 emits a laser beam from its light-emitting point to a condensing lens 2a in the optical unit 2. The condensing lens 2a condenses the laser beam emitted from the laser source 1. A scan mirror 2b is arranged behind the condensing lens 2a. The scan mirror 2b deflects the laser beam condensed by the condensing lens 2a.

With the laser beam deflected by the scan mirror 2b, the bar code is irradiated so as to be scanned while the bar code scanner 100 is directed to the bar code. An image-forming lens 2c receives light reflected from the bar code and forms an image of the barcode light on a photoelectric converter 3a in the signal-converting unit 3. The photoelectric converter 3a receives the reflected light and converts it to an electric signal in response to its intensity and outputs this signal to a current/voltage converter (I/V converter) 3b. The I/V converter 3b outputs a voltage signal in which a current value of the electric signal is converted into its voltage value and provides this signal to the signal-processing unit 7. Thus, the signal-converting unit 3 receives the reflected light of the laser beam with which the laser source 1 irradiates the bar code and converts it to an electric signal and outputs the electric signal to the signal-processing unit 7.

The signal-processing unit 7 binarizes the electric signal to generate a binarization signal. The signal-processing unit 7 is provided with a preamplifier 7a, a differentiator 7b, an automatic gain control (AGC) circuit 7c, an equalizer 7d, an output amplifier 7f and a binarization processing unit 7g. The preamplifier 7a amplifies the voltage signal received from I/V converter 3b and outputs it to the differentiator 7b. The differentiator 7b differentiates the amplified voltage signal to generate a differential signal and outputs it to the AGC circuit 7c. The AGC circuit 7c automatically adjusts an amplification factor (gain) of the amplification circuit so that a certain output can be obtained even if the amplitude of the differential signal varies.

The equalizer 7d removes any noise from the differential signal received from the AGC circuit 7c and outputs to the output amplifier 7f the differential signal on which a waveform equalization is performed. The output amplifier 7f amplifies the amplitude of the differential signal up to about five times and outputs it to the binarization processing unit 7g.

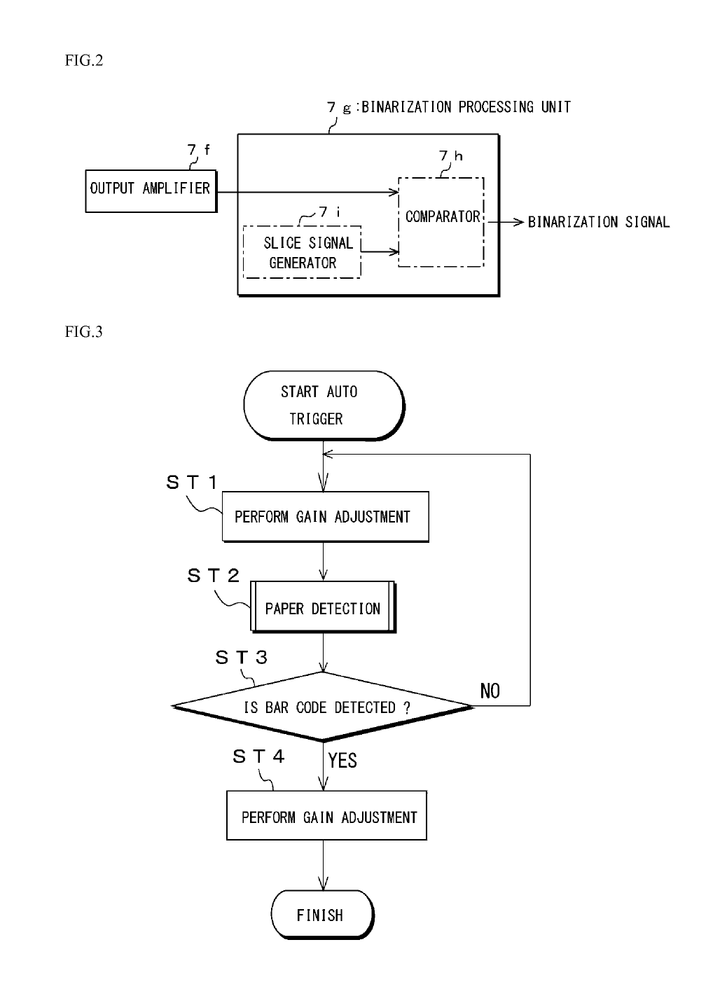

The binarization processing unit 7g generates a binarization signal based on the differential signal. For example, the binarization processing unit 7g shown in FIG. 2 is provided with a comparator 7h and a slice signal generator 7i. The slice signal generator 7i outputs to the comparator 7h a slice signal that is a reference for judging an inflection point of black and white in the bar code. The comparator 7h receives the slice signal from the slice signal generator 7i and the differential signal from the output amplifier 7f. The comparator 7h compares the received slice and differential signals to generate the binarization signal. For example, the comparator 7h generates the binarization signal so that a signal of high level is output when the differential signal is higher than the slice signal but a signal of low level is output when the differential signal is lower than the slice signal. The binarization processing unit 7g outputs the binarization signal to the CPU 4 which is an example of a control unit. It is to be noted that the level of the slice signal may be controlled according to the amplitude of the differential signal.

The CPU 4 decodes the binarization signal to read the bar code. For example, the CPU 4 generates an interrupt at the timing of an edge of the binarization signal to obtain a width of the bar code. In this example, the CPU 4 is provided with an interrupt controller 5 and a timer 6. The interrupt controller 5 generates an interrupt to the timer 6 at a timing of a rising edge in the binarization signal. The timer 6 seeks for an interval (a time interval) between the edges of the binarization signal when the interrupt occurs so that the width of the bar code is obtained from the interval between the edges. The CPU 4 compares the width of the bar code with a threshold value thereof to determine if it is a thick bar or a fine bar and converts it to a bar code character to read the bar code.

The OSC 15 shown in FIG. 1 oscillates to output a set clock signal to the PLL circuit 16. For example, the OSC 15 outputs a clock signal of 4 MHz to the PLL circuit 16. The PLL circuit 16 multiplies the clock signal received from the OSC 15. For example, the PLL circuit 16 multiplies the clock signal of 4 MHz received from the OSC 15 by 12 times to generate the clock signal of 48 MHz. The CPU 4 operates based on the clock signal of 48 MHz generated by this PLL circuit 16.

ROM 9 stores a real time OS (for example, μITron) of the bar code scanner 100 or the like, which is referred to by the CPU 4. Execution units of the real time processing are mainly classified into a task and a handler. The task is started, interrupted, resumed and stopped on the basis of the real time OS. On the other hand, the handler is a program unit which is started through various kinds of events generated in or out of the CPU 4, not through any OS. The CPU 4 changes from the execution state into its interrupt-processing state when detecting an occurrence of the interruption and performs an interrupt handler registered in the CPU 4. Since OS cannot control the execution of the interrupt handler, the interrupt handler has a higher priority than that of the task to which any normal execution states of the CPU 4 are applied.

The RAM 8 is used as a working memory of the CPU 4. Through the key board 10, various kinds of instructions are input by an operator. The display 11 displays an operation state of the bar code scanner 100, an instruction by the operator or the like.

The bar code scanner 100 has an auto-trigger function which is equipped with a reading mode and a non-reading mode. The reading mode is an operation of reading the bar code which the laser source 1 irradiates with a laser beam and the non-reading mode is an operation of detecting the bar code which the laser source 1, power consumption of which is reduced, irradiates with the laser beam. For example, by operating a function key, not shown, of the key board 10, the auto-trigger function is set on. When setting the auto-trigger function on, the mode is changed from the reading mode to the non-reading mode. The auto-trigger function may be controlled so as to be automatically set on after a set period of time has elapsed with the bar code scanner not operated.

In a state where the auto-trigger function is set on and the non-reading mode is set, the laser source 1 is intermittently driven and gain of the signal obtained from the laser source 1 is set so as to increase. In this example, the laser source 1 irradiates with an interval of 0.5 sec. This enables the power consumption of the laser source 1 to be reduced. Further, the gain of the AGC circuit 7c is set to the maximum level thereof. This enables a bar code distant therefrom to be read. In this case, since the gain is set to the maximum level thereof, the bar code distant therefrom can be read but noise is increased based on the maximum gain so that it has a problem such that it is difficult to read a bar code of particularly, close range. As the solution of this problem, cut-off frequency is lowered by the equalizer 7d to make a pass band narrower, thereby removing the high frequency component thereof. Further, by raising the level of the slice signal of the slice signal generator 7i of the binarization processing unit 7g, only the inflection point of the differential signal is extracted. Thus, it is possible to detect the bar code even if the gain of the AGC circuit 7c is maximum.

The CPU 4 decodes the bar code detected in the non-reading mode and decides whether or not it is correct. The CPU 4 changes the mode from the non-reading mode to the reading mode if it is decided that the bar code detected in the non-reading mode is correct but the CPU 4 continues the non-reading mode if it is decided that the bar code is not correct. This enables the auto-trigger function which automatically triggers reading of the bar code to be realized by using the existing laser source 1. Therefore, it is possible to eliminate any conventional parts and/or special-purpose circuits for realizing the auto-trigger function so that the bar code scanner 100 can be downsized.

The following will describe an example of the function of the bar code scanner 100. In the reading mode, the laser beam is emitted continuously from a beam-emitting point of the laser source 1 of the bar code scanner 100. This laser beam is condensed by the condensing lens 2a of the optical unit 2. The condensed laser beam is deflected by the scan mirror 2b to irradiate the bar code therewith, thereby scanning the bar code.

The light is reflected from the bar code and the reflected light thus reflected is formed into an image (image-formed) on the photoelectric converter 3a by the image-forming lens 2c. The reflected light which is image-formed on the photoelectric converter 3a is converted to an electric signal in response to its intensity by the photoelectric converter 3a. The electric signal is converted by the current/voltage converter (I/V converter) 3b to a voltage signal in which a current value thereof is converted into its voltage value.

The voltage signal is amplified by the preamplifier 7a of the signal-processing unit 7 and is differentiated by the differentiator 7b after it has been amplified, thereby becoming the differential signal. The differential signal is amplified by the AGC circuit 7c. In this case, the gain of the AGC circuit 7c is set to a normal level to read the bar code. Any noise is removed from the differential signal amplified in the AGC circuit 7c by the equalizer 7d and the waveform equalization is performed thereon. Thereafter, the differential signal is amplified by the output amplifier 7f so that its amplitude is increased up to about five times and is binarized by the binarization processing unit 7g, thereby allowing the binarization signal to be generated.

The CPU 4 generates an interrupt at the timing of an edge of the binarization signal to obtain a width of the bar code, compares the obtained width of the bar code with a threshold value thereof to determine whether it is a thick bar or a fine bar and converts it to a bar code character to read the bar code.

On the other hand, in a state where the auto-trigger function is set on and the non-reading mode is set, the laser beam is intermittently emitted from a beam-emitting point of the laser source 1 of the bar code scanner 100. This laser beam is condensed by the condensing lens 2a of the optical unit 2. The condensed laser beam is deflected by the scan mirror 2b to irradiate the bar code therewith, thereby scanning the bar code.

The light is reflected from the bar code and the reflected light thus reflected is image-formed on the photoelectric converter 3a by the image-forming lens 2c. The reflected light which is image-formed on the photoelectric converter 3a is converted to an electric signal in response to its intensity by the photoelectric converter 3a. The electric signal is converted by the current/voltage converter (I/V converter) 3b to the voltage signal in which a current value thereof is converted into its voltage value.

The voltage signal is amplified by the preamplifier 7a of the signal-processing unit 7 and is differentiated by the differentiator 7b after it has been amplified, thereby becoming the differential signal. The differential signal is amplified by the AGC circuit 7c. In this case, the gain of the AGC circuit 7c is set to a maximum level. Any noise is removed from the differential signal amplified by the AGC circuit 7c by the equalizer 7d, a cut-off frequency of which is reduced, and the waveform equalization is performed thereon. Thereafter, the differential signal is amplified by the output amplifier 7f so that its amplitude is increased up to about five times and is binarized by the binarization processing unit 7g which raises a level of its slice signal, thereby allowing the binarization signal to be generated.

The CPU 4 generates an interrupt at the timing of an edge of the binarization signal to obtain a width of the bar code, compares the obtained width of the bar code with a threshold value thereof to determine if it is a thick bar or a fine bar, converts it to a bar code character to detect the bar code, and decides whether or not the detected bar code is correct. For example, the CPU 4 compares the number of detected samples of the bar code detected in the non-reading mode with a reference number of samples of the bar code and decides that the detected bar code is correct if the number of detected samples lies within a range of the reference number of samples and if the value of each of the detected samples of the bar code does not exceed the value of the reference sample when comparing the value of each of the detected samples of the bar code thus detected with the value of the reference sample of the bar code. The CPU 4 changes the mode from the non-reading mode to the reading mode if it decides that the bar code detected in the non-reading mode is correct and continues the non-reading mode if it decides that the bar code is not correct.

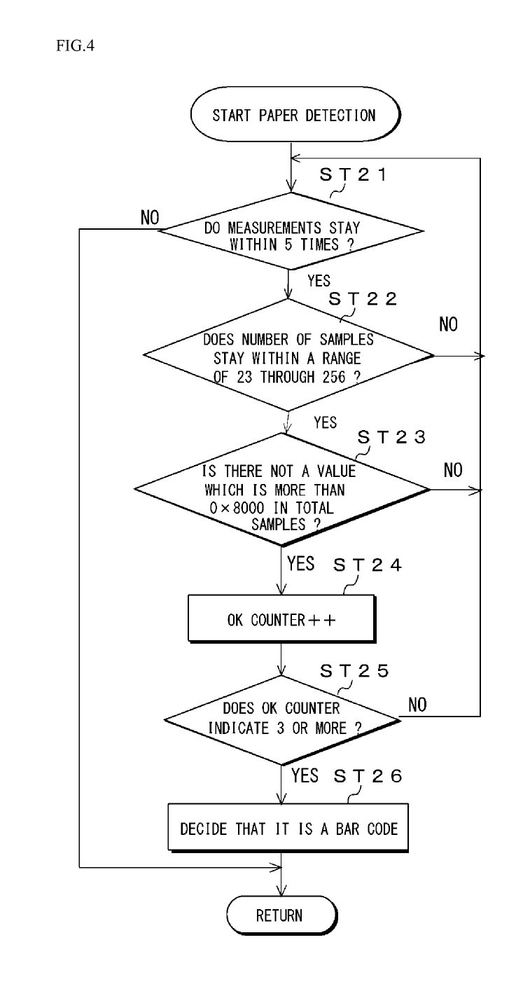

The following will describe operations of the auto-trigger function in detail with reference to FIGS. 3 and 4. In this example, by operating a function key, not shown, of the key board 10, the auto-trigger function is set on. When setting the auto-trigger function on, the non-reading mode is set. For example, at a step ST1 shown in FIG. 3, a gain adjustment or the like is performed. In this example, the CPU 4 controls the laser source 1 to irradiate with an interval of 0.5 sec, which enables the power consumption of the laser source 1 to be reduced. The signal-processing unit 7 sets the gain of the AGC circuit 7c to the maximum level thereof so that a bar code distanced therefrom can be read. Further, the signal-processing unit 7 causes the cut-off frequency to be lowered by the equalizer 7d, to make the pass band narrower, thereby removing the high frequency component thereof. Additionally, it sets so that, by raising the level of the slice signal of the slice signal generator 7i of the binarization processing unit 7g, only the inflection point of the differential signal is extracted. The processing goes to a step ST2.

At the step ST2, the bar code scanner 100 carries out a paper detection. The following will describe paper detection processing at step ST2 in detail with reference to a flowchart shown in FIG. 4. At a step ST21 shown in FIG. 4, it is decided whether or not the scans (measurements) of the bar code by the laser beam of the laser source 1 stay within five times. In this example, samples of the bar codes up to 5 times from a start of the laser source 1 are obtained. If the scans of the bar code exceed 5 times, the processing goes to step ST3 shown in FIG. 3. If the scans of the bar code stay within 5 times, the processing goes to a step ST22.

At the step ST22, the CPU 4 compares a number of detected samples of the bar code with a reference number of samples of the bar code and decides whether or not the number of detected samples lies within a range of the reference number of samples. For example, the CPU 4 generates an interrupt at the timing of an edge of the binarization signal received from the signal-processing unit 7 to obtain the width of the bar code, compares the obtained width of the bar code with a threshold value thereof to determine if it is a thick bar or a fine bar and converts it to a bar code character, to detect the bar code. The CPU 4 compares the number of detected samples of the detected bar code with a reference number of samples (for example, 23 through 256) of the bar code and decides whether or not the number of detected samples lies within the range of the reference number of samples. If the number of detected samples does not lie within the range of the reference number of samples, processing returns to the step ST21. If the number of detected samples stands within the range of the reference number of samples, the processing goes to a step ST23.

At the step ST23, the CPU 4 compares the value of each of the detected samples of the bar code thus detected with the value of the reference sample of the bar code to decide whether or not the value of each of the detected samples does not exceed the value of the reference sample. For example, the CPU 4 compares the value of each of the detected samples with the value of the reference sample (for example, 0x8000) of the bar code and decide that there is a bar which is thicker than a thick reference bar if the value of each of the detected samples exceeds the value of the reference sample, and the processing returns to the step ST21. If the value of each of the detected samples does not exceed the value of the reference sample, the processing goes to step ST24.

At step ST24, the CPU 4 increments an OK counter and the processing goes to step ST25. At step ST25, the CPU 4 determines whether or not the OK counter indicates a number not less than 3. If it determines that the OK counter indicates a number less than 3, the processing returns to the step ST21. If it determines that the OK counter indicates a number not less than 3, the processing goes to a step ST26. At the step ST26, the CPU 4 decides that a bar code is detected and the processing goes to the step ST3.

At the step ST3 shown in FIG. 3, the CPU 4 decides whether or not the bar code is detected. If it decides that the bar code is not detected, the processing returns to the step ST1 where the gain adjustment or the like is again performed. If it decides that the bar code is detected, the processing goes to a step ST4.

At the step ST4, the gain adjustment or the like is performed. For example, the CPU 4 controls the laser source 1 to irradiate continuously. The signal-processing unit 7 sets the gain of the AGC circuit 7c to a normal level to read the bar code. Further, the signal-processing unit 7 returns the cut-off frequency to the original one by the equalizer 7d and returns the level of the slice signal of the slice signal generator 7i of the binarization processing unit 7g to the original one to set the reading mode, which finishes the auto-trigger function.

Thus, by the bar code scanner 100 according to this invention, a bar code which is irradiated with the laser beam from laser source 1, power consumption of which is reduced in non-reading mode, is detected and it is decided whether or not the detected bar code is correct. The mode is changed from the non-reading mode to the reading mode if it decides that the code symbol is correct. The non-reading mode continues if it decided that the code symbol is not correct.

This enables the auto-trigger function that triggers reading of the bar code automatically to be realized using the existing laser source 1. Therefore, it is possible to eliminate some conventional parts and/or special-purpose circuits for realizing the auto-trigger function so that the bar code scanner 100 can be downsized.

It is to be noted that in order to reduce the consumption power of the laser source 1 in the non-reading mode, light may be emitted dimly by reducing the power to be supplied to the laser source 1, as well as the laser source 1 may be driven intermittently.

Although the bar code scanner which reads a one-dimensional bar code has been described in this embodiment, this invention is not limited thereto: It is also applicable to a code scanner which reads a code symbol such as a two-dimensional code or the like.

The present invention is very preferable to an optical-information-reading apparatus that reads information on a code symbol composed of portions having different optical reflectivity.

### DESCRIPTION OF REFERENCE CHARACTERS

1: Laser Source;
2: Optical Unit;
3: signal-Converting Unit;
4: CPU (Control Unit);
7: Signal-Processing Unit; and
100: Bar Code Scanner (Optical-Information-Reading Apparatus)

What is claimed:

1. An optical-information-reading apparatus that reads information in code symbols composed of portions having different optical reflectivity, in which an operation of reading a code symbol which is irradiated with a light source operating substantially with full power consumption constitutes a reading mode and an operation of detecting a code symbol which is irradiated with the light source operating with reduced power consumption constitutes a non-reading mode, the apparatus comprising:
a signal-converting unit that receives light from the light source reflected from the code symbol and converts it to an electric signal;
a signal-processing unit that binarizes the electric signal to generate a binarized signal; and
a control unit that decodes the binarized signal to detect a code symbol, the control unit determining when a code symbol detected in the non-reading mode is correct and changing the mode from the non-reading mode to the reading mode.

2. The apparatus of claim 1 wherein the light source produces a laser beam which is directed at the code symbol.

3. The apparatus according to claim 1 wherein the control unit enables continuation of the non-reading mode if it determines that the code symbol is not correct.

4. The apparatus according to claim 1 wherein the control unit compares a number of samples of the code symbol detected in the non-reading mode with a reference number of samples of the code symbol and determines that a detected code symbol is correct if the number of detected samples lies within a range of the reference number of samples and if a value of each detected sample does not exceed a value of a reference sample of the code symbol when the control unit does its comparison.

5. The optical-information-reading apparatus according to claim 1 wherein in the non-reading mode, the light source is intermittently driven and the gain of a signal obtained from the light source is increased.

6. A control method for an optical-information-reading apparatus that reads information on a target containing a code symbol, which is composed of portions having different optical reflectivity, an operation of reading a code symbol which is irradiated with a light source operating at substantially full power defining a reading mode and an operation of detecting a code symbol which is irradiated with a light source operating with reduced power consumption defining a non-reading mode, the method comprising steps of:
receiving light from the light source which has been reflected from the code symbol and converting it to an electric signal;
binarizing the electric signal to generate a binarized signal; and
decoding the binarized signal to detect the code symbol, including, as a sub-step, deciding when a code symbol detected in the non-reading mode is correct and changing the mode from the non-reading mode to the reading mode.
